(19) United States
(12) Patent Application Publication
(10) Pub. No.: US 2024/0110420 A1
(43) Pub. Date: Apr. 4, 2024

(54) GARAGE DOOR ASSEMBLY WITH COMPACT STORAGE

(71) Applicants: Amit Saha, Hudson, OH (US); Axel Schaedler, Olmsted Falls, OH (US)

(72) Inventors: Amit Saha, Hudson, OH (US); Axel Schaedler, Olmsted Falls, OH (US)

(21) Appl. No.: 18/375,679

(22) Filed: Oct. 2, 2023

Related U.S. Application Data
(60) Provisional application No. 63/412,627, filed on Oct. 3, 2022.

(51) Int. Cl. E05D 15/56; E05F 15/684

(52) U.S. Cl. CPC E05D 15/56; E05F 15/684; E05Y 2201/652; E05Y 2201/684; E05Y 2900/106

(57) ABSTRACT

A garage door assembly includes a plurality of hingedly connected panels are configured to movably engage a pair of guide rails. The guide rails include a substantially straight lower portion and a curved upper portion, where the curved upper portion has a variable radius of curvature. This configuration allows for compact housing of the garage door panels when the garage door is in an open configuration, allowing for a more compact overall footprint within a garage.

### FIELD OF THE INVENTION

Aspects of the disclosed technology relate to garage door assemblies and other moving door assemblies, and, more particularly, to a garage door assembly having a compact storage feature.

### BACKGROUND

Some conventional garage door assemblies for homes and other buildings include door panels that are hinged together, where the door is configured to move between a closed position, where the door panels obstruct and opening in the building, and a raised or open position, where the door panels are stored above the door opening such that the opening in the building is not obstructed. Many garage door assemblies are configured to have the door panels near the ceiling with the door panels generally in a horizontal orientation when the door is in the open position. This configuration tends to obstruct a large area of the ceiling and requires a larger frame work of rails and supports. This type of configuration results in the ceiling space being unusable for storage or other uses.

### BRIEF SUMMARY

Aspects of the disclosed technology relate to a garage door assembly where hingedly connected panels are configured to movably engage rails, where the rails include a substantially straight lower portion and a curved upper portion, where the curved upper portion has a variable radius of curvature. This configuration allows for compact housing of the garage door panels when the garage door is in an open configuration, allowing for a more compact overall footprint within a garage.

One aspect of the disclosed technology relates to a garage door assembly that includes a plurality of panels hingedly coupled to each other; a pair of guide rails disposed on opposite sides of the panels, wherein the panels are configured to movably engage the guide rails such that the door panels can move up and down along a path defined by the guide rails between a door closed position and a door open position; wherein each guide rail includes a substantially straight lower portion and a curved upper portion, the curved upper portion having a variable radius of curvature; and a motor operatively coupled to the door panels and configured to move the door panels upward and downward along the path defined by the guide rails.

According to one feature, the curved upper portion of each guide rail is configured to accommodate the plurality of panels without the plurality of panels overlapping one another.

According to one feature, the curved upper portion of each guide rail has a vertical extent and a horizontal extent, wherein the horizontal extent of the curved upper portion of each guide rail is less than twice the length of each door panel.

According to one feature, the curved upper portion of each guide rail has a vertical extent and a horizontal extent, wherein the horizontal extent of the curved upper portion of each guide rail is between about 1.5 times the length of each door panel and about 2.0 times the length of each door panel.

According to one feature, the plurality of door panels have a height X when vertically disposed in the door closed position and the horizontal extent of the curved upper portion of each guide rail is less than about half of the height X.

According to one feature, the plurality of door panels have a height X when vertically disposed in the door closed position and the horizontal extent of the curved upper portion of each guide rail is less than about 0.40 times the height X.

According to one feature, the garage door assembly includes a horizontal member positioned adjacent the curved upper portion of the guide rails; wherein the motor is operatively coupled to the horizontal member and configured to cause rotational motion of the horizontal member.

According to one feature, the horizontal member is operatively coupled to a torsion spring.

According to one feature, the horizontal member is operatively coupled to a lift-assist member.

According to one feature, the motor is operatively coupled to one or more of the panels through a drive assembly.

According to one feature, the drive assembly comprises a chain and sprocket assembly.

According to one feature, the chain and sprocket assembly includes an upper sprocket operatively coupled to the horizontal member, a lower sprocket, and a chain loop that movably engages the upper sprocket and the lower sprocket.

According to one feature, at least one of the door panels is operatively coupled to a portion of the chain loop.

According to one feature, the chain and sprocket assembly includes a pair of upper sprockets operatively coupled to opposite ends of the horizontal member; a pair of lower sprockets disposed below the respective upper sprockets; and a pair of chain loops, each chain loop being operatively coupled to and movable engaging respective pairs of upper and lower sprockets.

According to one feature, the drive assembly comprises a gear and belt drive assembly.

According to one feature, the drive assembly comprises a pair of rotating engagement members and a flexible member operatively coupled to the rotating engagement members such that rotation of the rotating engagement members causes movement of the flexible member.

According to another aspect of the disclosed technology, a guide rail assembly for use with a garage door assembly having a plurality of panels hingedly coupled to each other is provided. The guide rail assembly includes a pair of guide rails configured to be disposed on opposite sides of the panels and configured to movably support the panels; wherein each guide rail includes a substantially straight lower portion and a curved upper portion, the curved upper portion having a variable radius of curvature.

According to one feature, the curved upper portion of each guide rail is configured to accommodate the plurality of panels without the plurality of panels overlapping one another.

According to one feature, the curved upper portion of each guide rail has a vertical extent and a horizontal extent, wherein the horizontal extent of the curved upper portion of each guide rail is less than twice the length of each door panel.

According to one feature, the curved upper portion of each guide rail has a vertical extent and a horizontal extent, wherein the horizontal extent of the curved upper portion of each guide rail is between about 1.5 times the length of each door panel and about 2.0 times the length of each door panel.

According to one feature, the plurality of door panels have a height X when vertically disposed in the door closed position and the horizontal extent of the curved upper portion of each guide rail is less than about half of the height X.

According to one feature, the plurality of door panels have a height X when vertically disposed in the door closed position and the horizontal extent of the curved upper portion of each guide rail is less than about 0.40 times the height X.

These and further features of the disclosed technology will be apparent with reference to the following description and attached drawings. In the description and drawings, particular embodiments or aspects of the disclosed technology have been disclosed in detail as being indicative of some of the ways in which the principles of the disclosed technology may be employed, but it is understood that the disclosed technology is not limited correspondingly in scope. Rather, the disclosed technology includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, steps or components, but does not preclude the presence or addition of one or more other features, steps, components or groups thereof.

### DRAWINGS

These and other features of the disclosed technology, and its advantages, are illustrated specifically in embodiments now to be described, by way of example, with reference to the accompanying diagrammatic drawings.

FIG. 1 is a diagrammatic illustration of a conventional garage door assembly.

FIG. 2 is a diagrammatic illustration of a garage door assembly illustrating principles related to the disclosed technology;

FIG. 3 is a diagrammatic illustration of a garage door assembly according to aspects of the disclosed technology;

FIG. 4 is a diagrammatic illustration of a garage door assembly in a closed position according to aspects of the disclosed technology;

FIG. 5 is a diagrammatic illustration of a garage door assembly in a partially open position according to aspects of the disclosed technology;

FIG. 6 is a diagrammatic illustration of a garage door assembly in a partially open position according to aspects of the disclosed technology;

FIG. 7 is a diagrammatic illustration of a garage door assembly in an open position according to aspects of the disclosed technology;

FIG. 8 is a diagrammatic illustration of a portion of a garage door assembly in a closed position according to aspects of the disclosed technology;

FIG. 9 is a diagrammatic illustration of a portion of a garage door assembly in a partially open position according to aspects of the disclosed technology;

FIG. 10 is a diagrammatic illustration of a portion of a garage door assembly in a partially open position according to aspects of the disclosed technology;

FIG. 11 is a diagrammatic illustration of a portion of a garage door assembly in an open position according to aspects of the disclosed technology;

FIG. 12 is a diagrammatic illustration of a portion of a guide rail of a garage door assembly according to aspects of the disclosed technology;

FIG. 13 is a diagrammatic illustration of a garage door assembly according to aspects of the disclosed technology; and

FIG. 14 is a diagrammatic illustration of a garage door assembly showing example dimensions according to aspects of the disclosed technology.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION AND DRAWINGS

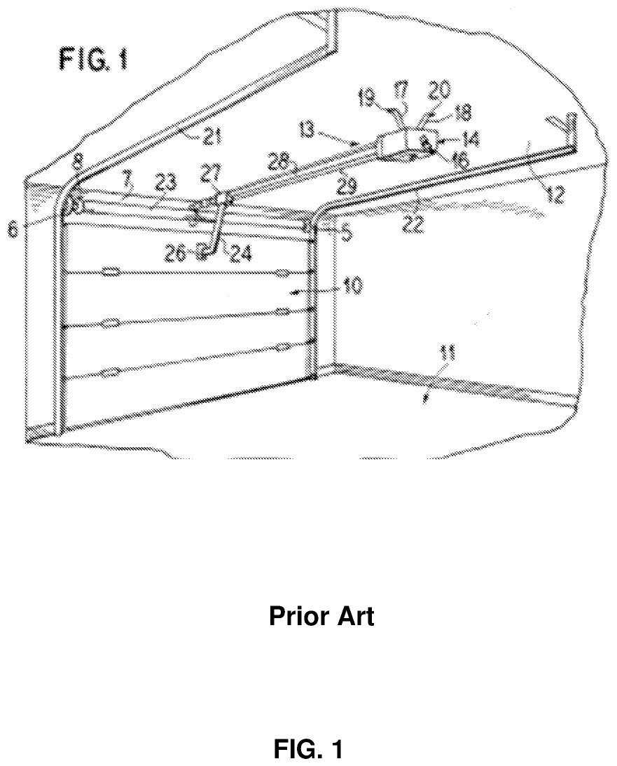

The present disclosure recognizes that many conventional garage door assemblies are configured to have the door panels near the ceiling with the door panels generally co-planar with one another and in a generally horizontal orientation when the door is in an open position. This configuration tends to obstruct a large area of the ceiling and requires a larger frame work of rails and supports. This type of configuration results in the ceiling space being unusable for storage or other uses. An example of a conventional garage door assembly is shown in FIG. 1.

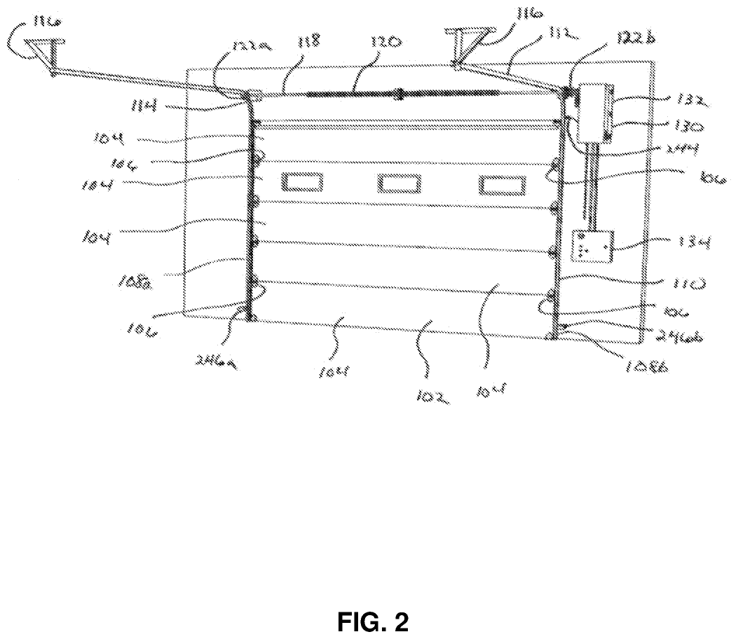

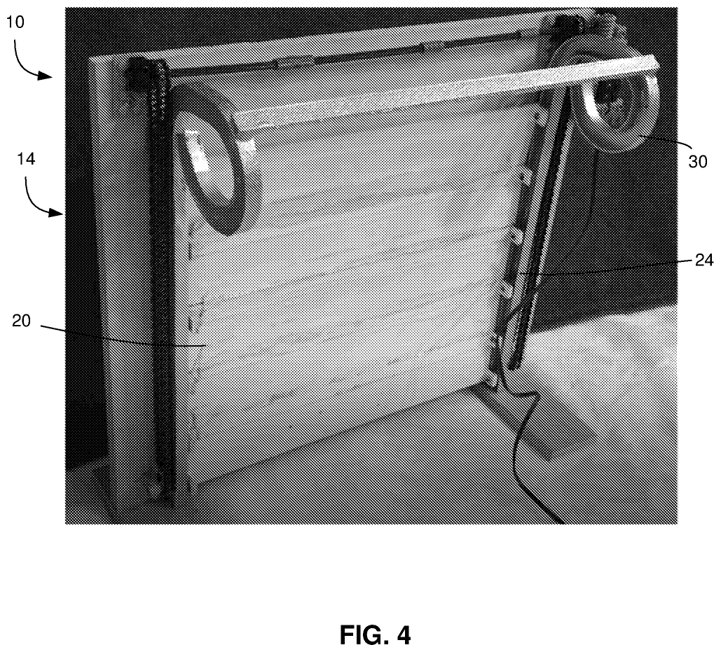

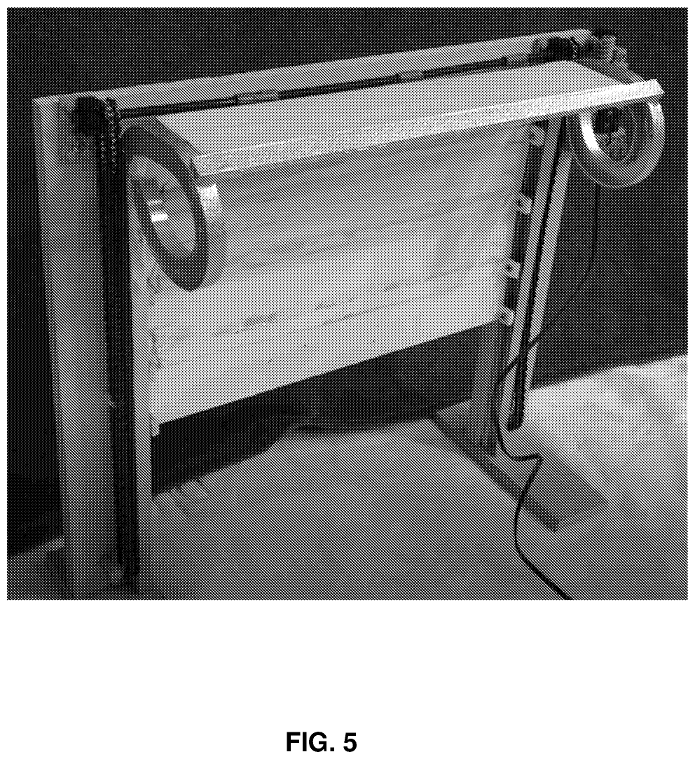

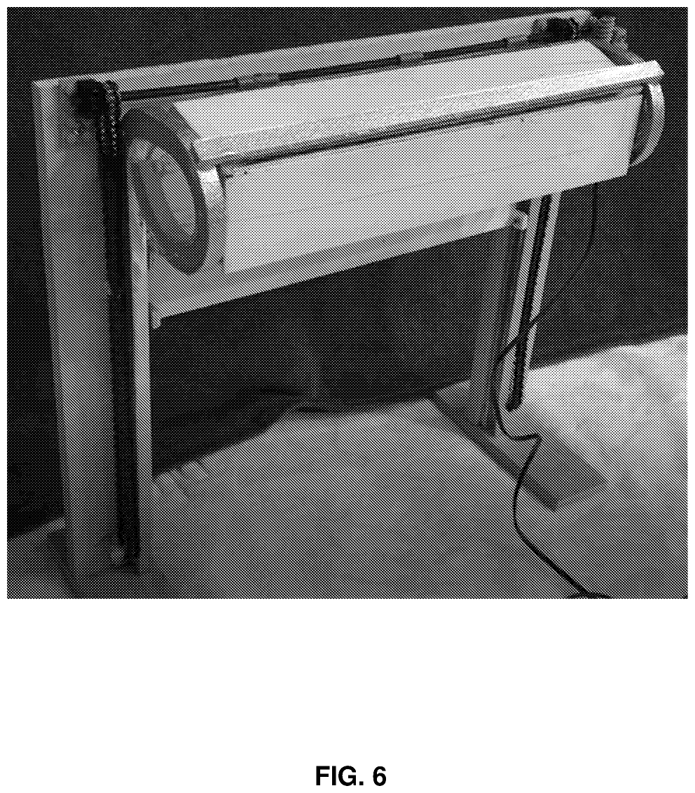

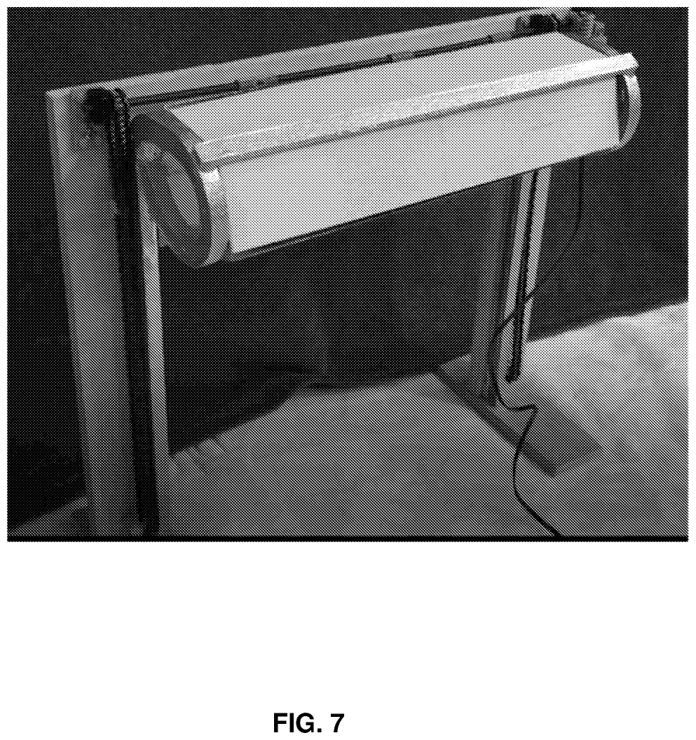

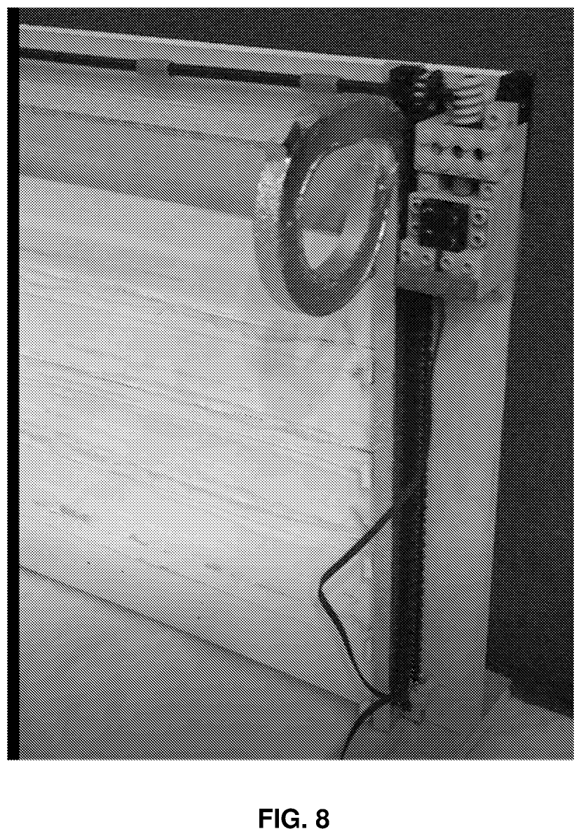

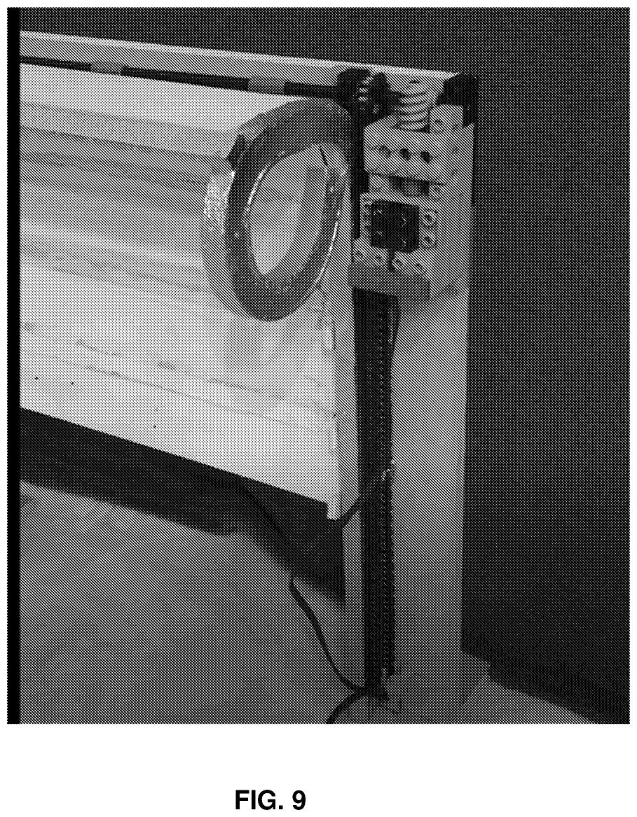

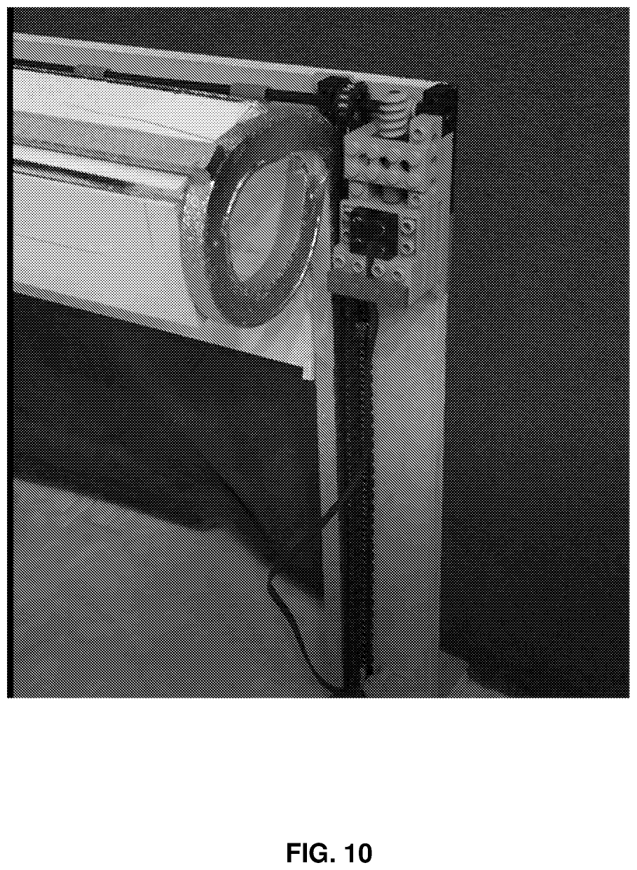

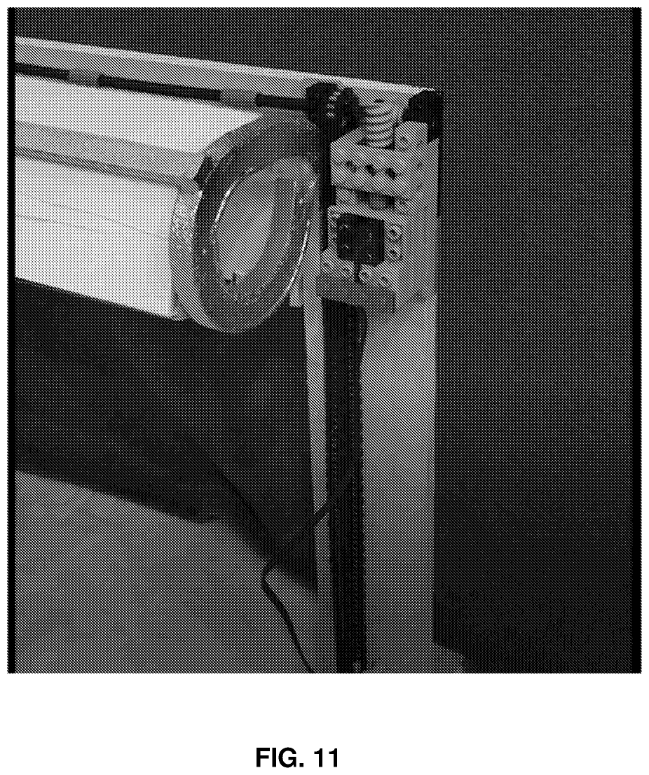

With reference to FIGS. 2-11, an exemplary embodiment of the garage door assembly 10 is provided. The garage door assembly 10 can be operatively coupled to the garage or other structure with which the door assembly is used by a suitable support system (e.g., a system of brackets, supports and trusses). In accordance with one exemplary implementation, guide rails 14 can be mounted to or otherwise supported by support structures on opposite sides of the door opening and/or above the door opening. FIG. 2 shows an example of a support system suitable for use in connection with aspects of the disclosed technology. The guide rails can be configured in a number of different ways without departing from the scope of the disclosed technology. For example, the guide rails 14 can be configured to have a generally U-shaped or C-shaped cross section in a manner suitable for movably supporting door panels of the garage door assembly.

It will be appreciated that the door panels 20 can be operatively coupled to the guide rails 14 in a number of different ways without departing from the scope of the disclosed technology. For example, the garage door assembly can be configured such that a plurality of panels are hingedly coupled together. The door panels can be operatively coupled to rollers are other suitable members that are configured to movably engage the guide rails, for example, by moving within channels defined by the guide rails between a door closed position and a door open position.

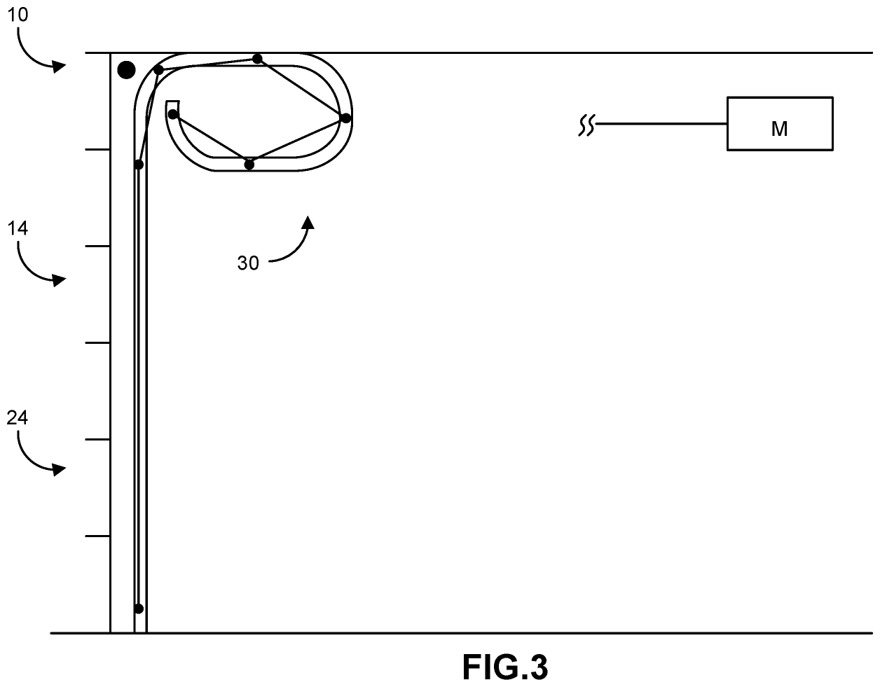

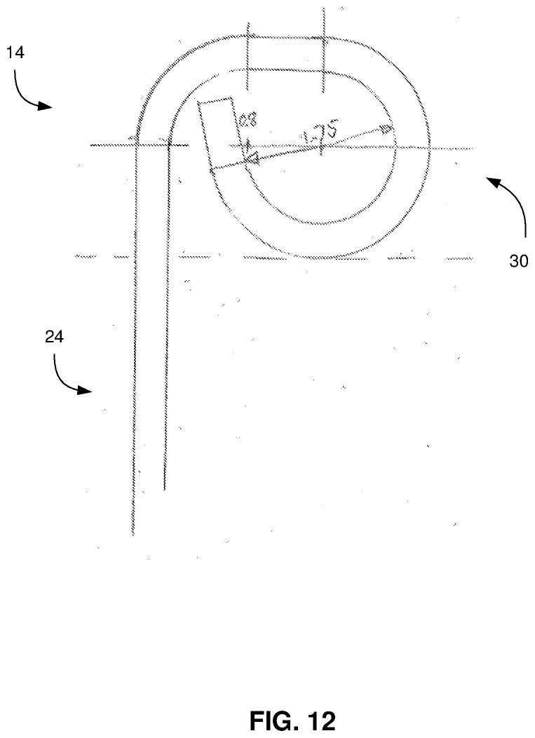

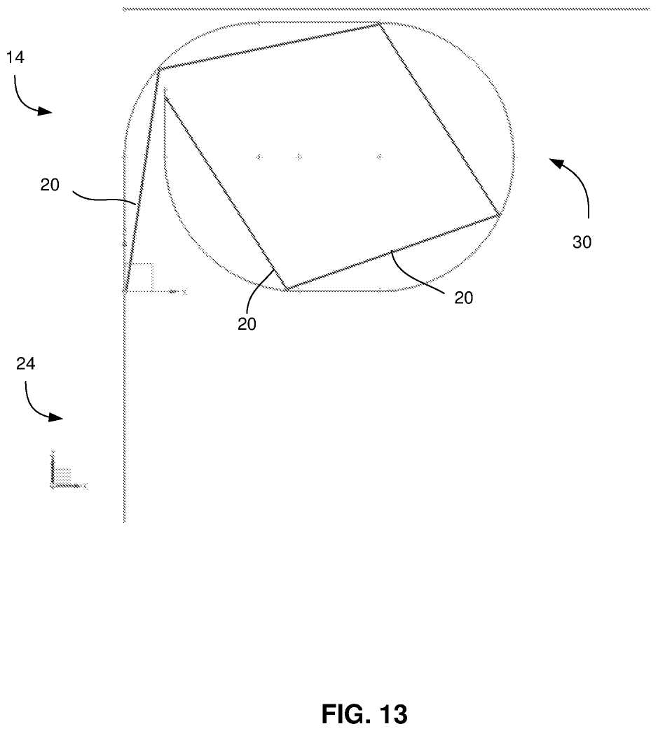

As illustrated in FIGS. 3-14, each guide rail 14 can be configured to include a substantially straight lower portion (indicated generally by reference number 24) and a curved upper portion (indicated generally by reference number 30). As is discussed more fully below, the curved upper portion can be configured to have a variable radius of curvature, facilitating compact storage and support of the garage door panels when the garage door is in the open position.

The garage door assembly also includes a motor operatively coupled to the door panels and configured to move the door panels upward and downward along the path defined by the guide rails.

As shown in FIGS. 2-11 a horizontal member can be positioned adjacent the curved upper portion of the guide rails, for example, mounted to a portion of the garage or other structure above the opening that will be covered by the garage door. In accordance with one exemplary implementation, the motor can be positioned adjacent the horizontal member and operatively coupled to the horizontal member such that the motor can impart rotational motion to the horizontal member. The horizontal member can be operatively coupled to a torsion spring or other suitable lift-assist mechanism configured to offset or otherwise compensate for a portion of the weight of the garage door panels.

In accordance with one exemplary implementation, the motor can be operatively coupled to the horizontal member and the garage door panels through a drive mechanism. It will be appreciated that the drive mechanism can be configured in a number of different ways without departing from the scope of the disclosed technology. For example, the drive mechanism can be configured as a chain drive mechanism. For example, a pair of sprockets, gears or other suitable toothed rotational members can be spaced apart from one another with a chain engaging the pair of sprockets such that rotation motion of the sprockets causes the chain loop to rotate around each sprocket.

In accordance with one exemplary implementation a motor is mounted adjacent the horizontal member and operatively coupled to a drive mechanism. The drive mechanism is operatively coupled to one or more of the door panels, such that rotation of the motor causes rotation of the drive mechanism which imparts motion of the door panels between a closed configuration, where the door panels are abutting one another in a substantially vertical orientation, and an open configuration, where the door panels are disposed on and about the upper portion of the guide rails.

One or more of the door panels can be operatively coupled to the chains on each side such that movement of the chain imparts upward or downward movement of the door panels as they are movably supported by the guide rails. In accordance with one exemplary implementation one or more of the door panels (e.g., the bottom door panel) will be clamped or otherwise coupled to the chains on both sides of each door panel. In accordance with another exemplary implementation, one or more of the door panels can be operatively coupled to the chain through one or more master links incorporated within the chain. In accordance with another exemplary implementation, one or more of the door panels can be operatively coupled to one or more sprockets that ride on or are otherwise movably supported by the chain to move the garage door panels upward and downward based on drive from the motor. Of course, it will be appreciated that other drive assemblies can be employed without departing from the scope of the disclosed technology.

In accordance with one exemplary implementation, the horizontal member, which can include a torsion spring or other suitable lift-assist mechanism, will be operatively coupled to a pair of upper sprockets on opposite ends of the horizontal members. The pair of upper sprockets can cooperate with a pair of lower sprockets to movably support a pair of chain loops. One or more of the garage door panels can be operatively coupled on opposite ends to the pair of chain loops. The motor can be operatively coupled to one end of the horizontal member and configured to impart rotational motion on the horizontal member, which, in turn, will cause rotation of the sprockets and movement of the chain and garage door panels.

Referring now to FIGS. 3-14, as discussed above, each guide rail 14 includes a substantially straight lower portion 24 and a curved upper portion 30. The curved upper portion 30 is configured to have a variable radius of curvature, which aids in allowing for relatively compact support and storage of the garage door panels 20 when the garage door is in the open position. As can be seen in the drawings, the curved upper portion 30 of each guide rail 14 has a longitudinal extent and a lateral extent, wherein the lateral extent of the curved upper portion of each guide rail is less than twice the length of each door panel.

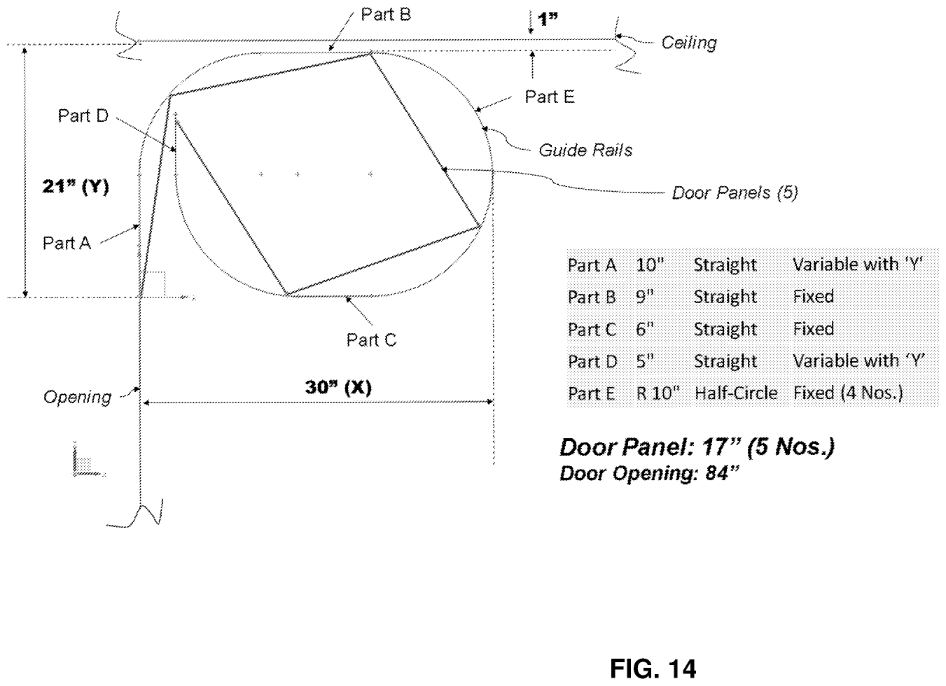

Referring now to FIG. 14, an exemplary embodiment of the garage door assembly is provided. While this embodiment is described with respect to exemplary values and configurations, it will be appreciated that the values and configuration can be modified without departing from the scope of the disclosed technology.

In accordance with one exemplary implementation, the upper curved portion 30 of the guide rails 14 can be configured such that the panels 20 can be stored or otherwise supported such that none of the panels are stored in a substantially horizontal orientation when the garage door is in the open position.

It will be appreciated that the curved upper portion 30 of each guide rail 14 is configured to accommodate the plurality of panels 20 without the plurality of panels overlapping one another.

In accordance with one exemplary implementation, the curved upper portion 30 of each guide rail 14 has a vertical extent and a horizontal extent, wherein the horizontal extent of the curved upper portion 30 of each guide rail 14 is less than twice the length of each door panel 20.

In accordance with another exemplary implementation, the curved upper portion of each guide rail has a vertical extent and a horizontal extent, wherein the horizontal extent of the curved upper portion of each guide rail is between about 1.5 times the length of each door panel and about 2.0 times the length of each door panel.

In accordance with another exemplary implementation, the plurality of door panels have a height X when vertically disposed in the door closed position and the horizontal extent of the curved upper portion of each guide rail is less than about half of the height X.

In accordance with another exemplary implementation, the plurality of door panels have a height X when vertically disposed in the door closed position and the horizontal extent of the curved upper portion of each guide rail is less than about 0.40 times the height X.

Although the disclosed technology has been shown and described with respect to a certain preferred aspect, embodiment or embodiments, it is obvious that equivalent alterations and modifications will occur to others skilled in the art upon the reading and understanding of this specification and the annexed drawings. In particular regard to the various functions performed by the above described elements (components, assemblies, devices, members, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary aspect, embodiment or embodiments of the disclosed technology. In addition, while a particular feature of the disclosed technology may have been described above with respect to only one or more of several illustrated aspects or embodiments, such feature may be combined with one or more other features of the other embodiments, as may be desired and advantageous for any given or particular application.

What is claimed is:

1. A garage door assembly comprising:
a plurality of panels hingedly coupled to each other;
a pair of guide rails disposed on opposite sides of the panels, wherein the panels are configured to movably engage the guide rails such that the door panels can move up and down along a path defined by the guide rails between a door closed position and a door open position;
wherein each guide rail includes a substantially straight lower portion and a curved upper portion, the curved upper portion having a variable radius of curvature; and
a motor operatively coupled to the door panels and configured to move the door panels upward and downward along the path defined by the guide rails.

2. The garage door assembly of claim 1, wherein the curved upper portion of each guide rail is configured to accommodate the plurality of panels without the plurality of panels overlapping one another.

3. The garage door assembly of claim 1, wherein the curved upper portion of each guide rail has a vertical extent and a horizontal extent, wherein the horizontal extent of the curved upper portion of each guide rail is less than twice the length of each door panel.

4. The garage door assembly of claim 1, wherein the curved upper portion of each guide rail has a vertical extent and a horizontal extent, wherein the horizontal extent of the curved upper portion of each guide rail is between about 1.5 times the length of each door panel and about 2.0 times the length of each door panel.

5. The garage door assembly of claim 4, wherein the plurality of door panels have a height X when vertically disposed in the door closed position and the horizontal extent of the curved upper portion of each guide rail is less than about half of the height X.

6. The garage door assembly of claim 4, wherein the plurality of door panels have a height X when vertically disposed in the door closed position and the horizontal extent of the curved upper portion of each guide rail is less than about 0.40 times the height X.

7. The garage door assembly of claim 1, further comprising:
a horizontal member positioned adjacent the curved upper portion of the guide rails; wherein the motor is operatively coupled to the horizontal member and configured to cause rotational motion of the horizontal member.

8. The garage door assembly of claim 7, wherein the horizontal member is operatively coupled to a torsion spring.

9. The garage door assembly of claim 7, wherein the horizontal member is operatively coupled to a lift-assist member.

10. The garage door assembly of claim 7, wherein the motor is operatively coupled to one or more of the panels through a drive assembly.

11. The garage door assembly of claim 10, wherein the drive assembly comprises a chain and sprocket assembly.

12. The garage door assembly of claim 11, wherein the chain and sprocket assembly includes an upper sprocket operatively coupled to the horizontal member, a lower sprocket, and a chain loop that movably engages the upper sprocket and the lower sprocket.

13. The garage door assembly of claim 12, wherein at least one of the door panels is operatively coupled to a portion of the chain loop.

14. The garage door assembly of claim 11, wherein the chain and sprocket assembly comprises:
a pair of upper sprockets operatively coupled to opposite ends of the horizontal member;
a pair of lower sprockets disposed below the respective upper sprockets; and
a pair of chain loops, each chain loop being operatively coupled to and movable engaging respective pairs of upper and lower sprockets

15. The garage door assembly of claim 10, wherein the drive assembly comprises a gear and belt drive assembly.

16. The garage door assembly of claim 10, wherein the drive assembly comprises a pair of rotating engagement members and a flexible member operatively coupled to the rotating engagement members such that rotation of the rotating engagement members causes movement of the flexible member.

17. A guide rail assembly for use with a garage door assembly having a plurality of panels hingedly coupled to each other, the guide rail assembly comprising:
a pair of guide rails configured to be disposed on opposite sides of the panels and configured to movably support the panels;
wherein each guide rail includes a substantially straight lower portion and a curved upper portion, the curved upper portion having a variable radius of curvature.

18. The guide rail assembly of claim 17, wherein the curved upper portion of each guide rail is configured to accommodate the plurality of panels without the plurality of panels overlapping one another.

19. The guide rail assembly of claim 17, wherein the curved upper portion of each guide rail has a vertical extent and a horizontal extent, wherein the horizontal extent of the curved upper portion of each guide rail is less than twice the length of each door panel.

20. The guide rail assembly of claim 17, wherein the curved upper portion of each guide rail has a vertical extent and a horizontal extent, wherein the horizontal extent of the curved upper portion of each guide rail is between about 1.5 times the length of each door panel and about 2.0 times the length of each door panel.
